(19) United States
(12) Patent Application Publication
(10) Pub. No.: US 2005/0113726 A1
(43) Pub. Date: May 26, 2005

(54) Self-massage device

(76) Inventor: Keith Owen Prettyman, Escondido, CA (US)

Correspondence Address: Keith O. Prettymen, 1645 Hamilto Lane, Escondido, CA, 92029, US

(21) Appl. No.: 10/930,409

(22) Filed: Aug. 30, 2004

Related U.S. Application Data
(60) Provisional application No. 60/499,051, filed on Aug. 29, 2003.

(51) Int. Cl. A61H 15/00

(52) U.S. Cl. 601/119; 601/123; 601/125; 601/135

(57) ABSTRACT

The self-massage device of the present invention comprises an angled hook, two massage heads, an elongated shaft of sufficient length to serve as an efficient lever and to permit positioning of the massage heads at desired locations, and a handle that can serve as a fulcrum. The invented device massages and relieves tension and/or spasms when applied to the user's back, neck, legs, and hip area and used as described herein. Use of the device does not require the assistance of another person or device, and delivers a satisfying and effective massage to the target muscle or body area with minimal user effort. Importantly, the device creates a lever mechanical advantage in use that significantly multiplies the user's effort and transfers the multiplied effort to the targeted massage head.

### CROSS-REFERENCE TO RELATED APPLICATIONS

This application claims the benefit of U.S. Provisional Patent Applications No. 60/499,051, filed Aug. 29, 2003, where the provisional application is incorporated herein by reference in its entirety.

### BACKGROUND OF THE INVENTION

The present invention generally relates to the field of physical therapy, massage therapy and pain and stress management, more particularly relating to a hand-held, portable device useful for self-massage and stretching of muscles and spinal soft tissue, wherein the massaging action relies on the principles of lever/fulcrum mechanics.

Within the past decade, an overwhelming accumulation of scientific evidence has supported the claim that massage therapy is beneficial. Massage can benefit such conditions as muscle spasm and pain, spinal curvatures, soreness related to injury and stress, headaches, whiplash, temporomandibular joint syndrome (TMJ), and tension-related respiratory disorders such as bronchial asthma or emphysema. Massage can also help reduce swelling, help correct posture, improve body motion, and facilitate the elimination of toxins from the body. Massage is the most frequently used therapy for musculoskeletal problems, and is particularly useful in controlling pain.

Direct mechanical effect of rhythmically applied pressure and stretching (as done in massage) can dramatically increase the rate of blood flow. Also, the stimulation of nerve receptors causes the blood vessels (by reflex action) to dilate. Massage can help loosen contracted, shortened muscles and can stimulate weak, flaccid muscles. This muscle balancing can help posture and can provide for more efficient movement.

Massage increases blood supply to the connective tissue of the joints by releasing muscle tension that can bind them and by passively moving them. Massage also aids in recovery from injuries such as sprains, strains, and fractures. This is possible because the growth and recovery of tissue is accelerated by efficient circulation in the injured areas. Thus, massage helps bridge the gap between common neglect of injury and major medical intervention.

Stress causes the release of hormones that create vasoconstriction-vessel shrinking-and so reduced circulation. Affected by stress, the heart works harder, breathing becomes rapid and shallow, and digestion slows. Every body process is degraded.

Most hand-held self-massaging devices are quite limited in function. First, most self-massage devices are designed to massage areas on the front of a user's body, e.g., legs, arms, feet, side of the neck, and cannot reach the user's back or spinal column without great difficulty or engaging the very muscles the user is trying to relax. For instance, the handle of the hand-held massage device set forth in U.S. Pat. No. 3,856,002 is too short to permit a user to use the device effectively in massaging his spine or the scapula and rotator cuff area under either of his shoulder blades. Manufacturers of some self-massage devices address this limitation by incorporating a specially shaped handle, such as a U-, J- or S-shaped handle, into their device in order to reach and massage the back, spine, and other hard to reach areas of a user's body. See, e.g., the devices set forth in U.S. Pat. No. 4,266,536; U.S. D444,566S; U.S. Pat. No. 4,798,198; U.S. Pat. No. 5,560,746; U.S. Pat. No. 5,848,980; U.S. Pat. No. 6,261,251; U.S. Pat. No. 6,241,693. Unfortunately, such devices often require the user to awkwardly position one or both of his arms, or his body, in order to guide the massage head to the targeted massage area. Once positioned, the user has to manipulate the massage device by moving his arms or hands in an exaggerated manner. Not only can this be uncomfortable, but the mere use of such devices can exacerbate the muscle condition sought to be relieved, and undesirably engage the muscles to be massaged. Moreover, users having limited mobility experience difficulty using, or do not benefit at all, from such devices.

Massage heads attached to a conventional J-shaped handle can be used to reach the hard to reach areas a straight handled massage head simply cannot reach. However, the J-shape is especially prone to buckling or curving when pressure is placed upon it, such as when used as a self-massage device. To address this limitation, manufacturers must employ sturdier/more expensive materials when making conventional J-shaped devices, or at least increase the inner and outer diameters of the J-shape tube to increase its resistance to pressure. These design changes increase cost, generally increase the weight of the device, and make them less portable and effective.

Massage devices with short handles cannot be used as efficient lever/fulcrum mechanisms and, therefore, require a greater amount of user force in order to generate and transfer sufficient pressure to the muscle or area to be massaged. This is not a desired feature in a device designed to treat sore or pulled muscles, or designed for use by individuals having limited mobility or strength. Often short-handled self-massage devices address this problem by adding a motor or some other vibration-generating device that spares user energy, but limits the portability of the device. Additionally, these vibrating types of massagers are mostly superficial and although they do manage to increase blood flow to the skin surface, they are not effective in elongating shortened or spasmodic muscles, ligaments or tendons.

Self-massage devices for the back, spine and other hard to reach sites on the user's body often comprise only a single massage head or only one type of massage head. See, e.g., U.S. Pat. No. 5,730,708. While a user may obtain some degree of massage with such a device, a more efficient and complete massage is obtained from a versatile massage device comprised of multiple massage heads. The J-shaped device set forth in U.S. Pat. No. 6,758,826 optionally comprises multiple massage heads, and is said to be useful for reaching substantially any portion of the user's body without requiring contortions or twisting by the user. However, the disclosed configurations of that device limit the ways in which a user can position and thereby use that massage device effectively. Further limitations of that type of device are revealed when a user attempts to apply the pressure needed to release spasmodic muscles and connective tissue. The relatively small radius and handle length require a user to employ a significant amount of effort in order to feel an adequate amount of pressure at the massage head. As with other known devices, these limitations create barriers that may not be overcome by potential users having limited mobility or limited strength, such as aged individuals, physical therapy patients, and the like.

Also lacking among known devices is a versatile device that can be used by an individual or a third party, such as a physical therapist, that serves the dual purposes of (1) providing a therapeutic massage and spasmodic release and (2) use as a cane to allow the patient mobility without reactivating the injured or spasmodic muscles and connective tissue.

Therefore, a need exists for a self-massage device that (1) is of sufficient length to reach the muscles in the back of a user's body and his soft spinal tissue when used in either a vertical, diagonal or horizontal mode, (2) creates an efficient lever/fulcrum function such that requires minimal user effort to produce an amplified transfer of massage pressure to a target site, (3) withstands pressure placed on the device when used for massage or, in certain embodiments, when used as a cane, (4) comprises at least two different massage heads to permit massage of at least the muscles in the back, legs, hips, neck, shoulders, as well as the spinal area, and (5) has a sufficient inner edge length to permit the device to be positioned around the user's hip-section for use in a horizontal mode, positioned around the user's shoulder's for use in a longitudinal and diagonal mode, but maintains a relatively small distance between the massage head and the fulcrum to create an efficient lever/fulcrum effect.

### BRIEF SUMMARY OF THE INVENTION

In one embodiment, the invention comprises a device useful for self-massage comprising:
a. an angled hook having a first end and a second end,
b. a massage head positioned at the first end of the angled hook,
c. an elongated shaft having a first end and a second end,
d. a handle positioned between the angled hook and the elongated shaft, and
e. a pair of parallel massage rollers positioned on the elongated shaft such that the rollers rotate in a plane perpendicular to the length of the shaft, wherein the elongated shaft is of sufficient length to serve as an efficient lever and to permit positioning of the massage head and massage rollers at desired body locations.

In another embodiment, then invention comprises a device useful for self-massage and as a walking aid comprising:
a. an angled hook having a first end and a second end,
b. a massage head positioned at the first end of the angled hook,
c. an elongated shaft having a first end and a second end,
d. a handle positioned between the angled hook and the elongated shaft,
e. a pair of parallel massage rollers positioned on the elongated shaft such that the rollers rotate in a plane perpendicular to the length of the shaft, and
f. a cane tip, wherein the elongated shaft is of sufficient length to serve as an efficient lever and to permit positioning of the massage head and massage rollers at desired body locations.

Yet another embodiment of the present invention is a device useful for self-massage comprising:
a. an angled hook having a first end and a second end,
b. a massage head positioned at the first end of the angled hook, wherein the massage head is textured;
c. an elongated shaft having a first end and a second end,
d. a handle positioned between the angled hook and the elongated shaft, and
e. a pair of donut-shaped parallel massage rollers that encircle the elongated shaft and are freely rotatable around the shaft in a plane perpendicular to the shaft, wherein the angled hook, the handle, and the elongated shaft together define a five-sided angled hook shape comprising four angles on its inner edge, and wherein the elongated shaft is of sufficient length to serve as an efficient lever and to permit positioning of the massage head and massage rollers at desired body locations.

A further embodiment of the present invention comprises a device useful for self-massage comprising:
a. an angled hook having a first end and a second end,
b. a massage head positioned at the first end of the angled hook,
c. an elongated shaft having a first end and a second end,
d. a handle positioned between the angled hook and the elongated shaft, and
e. a pair of massage heads positioned on the elongated shaft such that the pair of massage heads is oriented perpendicular to the length of the shaft, wherein the elongated shaft is of sufficient length to serve as an efficient lever and to permit positioning of the massage head and massage rollers at desired body locations.

With respect to the four embodiments set forth above, the following preferences are applicable. In additional preferred embodiments, the angled hook, the handle, and the elongated shaft together define a five-sided angled hook shape comprising four angles on its inner edge. Further preferences of this embodiment include those in which the third hook side of the five-sided angled hook shape comprises a brand-marking feature and/or comprises a feature that enhances a user's grip. Preferred features according to this embodiment include padding, ergonomic configurations, handle attachments and grasping indentations. Also preferred in this embodiment is a device comprising at least two additional features selected from the group consisting of a brand-marking element, a detachable massage head, a telescoping elongated shaft, and a cane tip.

In other preferred embodiments, the device comprises at least one feature that performs a function selected from the group consisting of permitting the massage head to be detachable from the angled hook, permitting the massage head to be positioned at variable distances from the first end of the angled hook, and permitting the massage head to be positioned at variable angles from the first end of the angled hook such that the massage head is positioned at an angle toward or away from the elongated shaft.

Further preferred aspects of this embodiment of the invention include those wherein the massage head is textured, the elongated shaft is telescoping, the elongated shaft comprises a cane tip, the pair of parallel massage rollers or pair of massage heads are donut-shaped rollers that encircle the elongated shaft and that are freely rotatable around the shaft.

In embodiments in which the device functions as a self-massage device and a walking aid, it is preferred that the device comprises at least one additional feature selected from the group consisting of a brand marking element, a detachable massage head, a telescoping elongated shaft, and a feature that enhances a user's grip at the third hook side.

Another embodiment of the present invention is a kit comprised of the present self-massage device and a selection of two or more detachable massage heads A, and/or two or more detachable pairs of parallel massage rollers or pairs of massage heads, along with directions for use. This embodiment contemplates directions to be in the form of, or in any combination of, written, spoken, pictorial (still or moving), electronic, or computerized instruction. A preferred kit comprises instructions in written form and/or on in a DVD or videocassette format.

In a preferred embodiment, the elongated shaft is at least about 12 inches in length, with a length in the range of about 12 inches to about 36 inches being preferred, and a length of about 27 to 30 inches being especially preferred.

In a preferred embodiment, the position of massage head A relative to handle C is lower when the device is upright with the second end of the elongated shaft on the ground.

In a preferred embodiment, the distance between the massage head and the elongated shaft, as measured as described herein, is about 6 to about 12 inches, with a distance of about 8 to about 10 inches being preferred, and a distance of about 9 to about 9.5 being especially preferred.

In a preferred embodiment, the length of the inner edge portion of the angled hook (the distance from the first end of the angled hook to the second end of the angled hook, excluding the handle, elongated shaft, and massage head) is about 15 to about 20 inches, with a length of about 16 to about 19 inches being preferred, and a length of about 17 to about 18.5 inches being especially preferred.

In a preferred embodiment, the size of the angle at the angled junction of the hook side that joins with the massage head and the next adjacent hook side is about 25 to about 90 degrees, with an angle size of about 35 to about 45 degrees being preferred, and an angle size of about 45 degrees being especially preferred.

In a preferred embodiment, the members of the parallel massage rollers or the members of the pair of massage heads are spaced apart by a distance of about 1 inch to about 4 inches, with a distance of about 1¼ inches to about 1½ inches being preferred.

Other embodiments of the present invention include methods of using the invented device to effect self-massage.

### BRIEF DESCRIPTION OF THE DRAWINGS

FIG. 1A displays an embodiment of the present invention comprising an angled hook, two different massage heads A and D, a handle/fulcrum C, an elongated shaft comprising a cone tip, and the center of the arc, B, configured for use as a handle of a walking aid or comprising a brand marking feature. The embodiment displayed in FIG. 1A is a five-sided angled hook shape.

FIG. 1B displays a side view of the embodiment set forth in FIG. 1A.

FIG. 2 displays a method of using the present device for self-massage to relieve tension and stress along the upper shoulders and neck, as well as the area under the scapula and the mid-back/ribs areas.

FIG. 3 displays a side view of the method of using the present device as set forth in FIG. 2, wherein the device is placed on the right shoulder area.

FIG. 4 displays a method of using the device for self-massage to massage the lower back, sciatic nerve area and gluteus muscle with the parallel rollers D.

FIG. 5 displays a front view of the method set forth in FIG. 4.

FIG. 6 displays a method of using the device for self-massage to stretch the lower- and mid-back, and massage the area around the spine.

FIG. 7 displays an enlarged view of a five-sided angled hook shape found within some embodiments of the present invention.

FIG. 8 displays an enlarged view of the elongated shaft found within some embodiments of the present invention.

### DETAILED DESCRIPTION OF THE INVENTION

In the context of the present invention, the following terms have the stated meanings:

“Angled hook” means a laterally extending hook shaped element, having an inner edge and an outer edge, comprising two or more hook sides each of which joins with its adjacent side at angles. At minimum, an angled hook comprises a first hook side and a second hook side. In a preferred embodiment, the angled hook element has four sides and, when combined with the handle and the elongated shaft, forms a five-sided angled hook shape.

“Angled junction” means the junction point where one side of the angled hook joins to its adjacent side at an angle and thereby defines the size or degrees in the angle.

“Brand-marking feature” means a labeling or personalization feature. For instance, the brand name of the device can be affixed to the device in such a feature, as can a promotional slogan, logo, customer corporate logo, or other personalization feature. Such features can be incorporated into an element of the device (e.g., stamped into the device), or can be separately affixed or attached to the device (e.g., stickers, removable sleeves printed with branding).

“Comprising a feature” means that the element in question comprises one or more additional elements to provide the recited feature, or it is itself configured to have the recited feature without the addition of any other element. By way of non-limiting example, the third side of an angled hook can comprise a feature to make it more comfortable for a user to hold the device. An ergonomically preferred handle can be affixed to the third hook side to add this feature, or the third hook side can be configured to have an ergonomically preferred shape without the addition of any additional element.

“Desired body locations” means locations on a user's body to which he desires to apply self-massage, acupressure including hard to reach places such as the area surrounding the spinal column, the hips, the back, and under the shoulder blades.

“Detachable” means that an element can be attached and detached at user discretion. For instance, the massage head positioned at the end of the angled hook may be detachable to allow a user to pick and choose among a variety of massage heads. Similarly, a brand-marking feature may be detachable to permit easy application of the brand-marking, interchangeability of brand-marking, and the like.

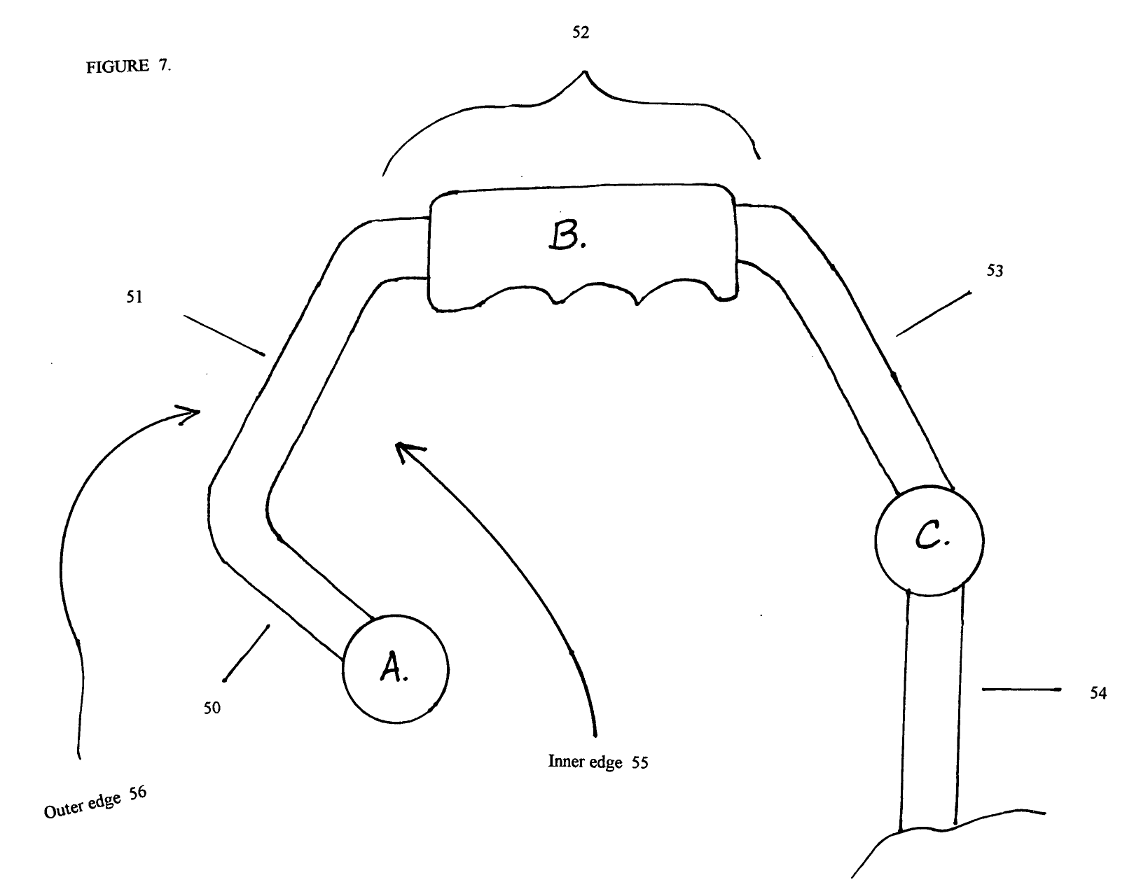

“Distance between the massage head and the elongated shaft” means the length of an imaginary straight line that could be drawn from a point on the massage head A (in FIG. 7) that faces the shaft 54, to the point on the shaft 54 that is perpendicular to shaft 54.

“Efficient lever” means that a lever functions to transfer and amplify a measure of user-applied force from the end of the lever to which pressure is amplified at a massage head, such as massage head A or the parallel massage rollers D. An efficient lever requires the application of a relatively small amount of user-applied pressure to one end of the lever in order to transfer a measurable increased amount of pressure to the massage head.

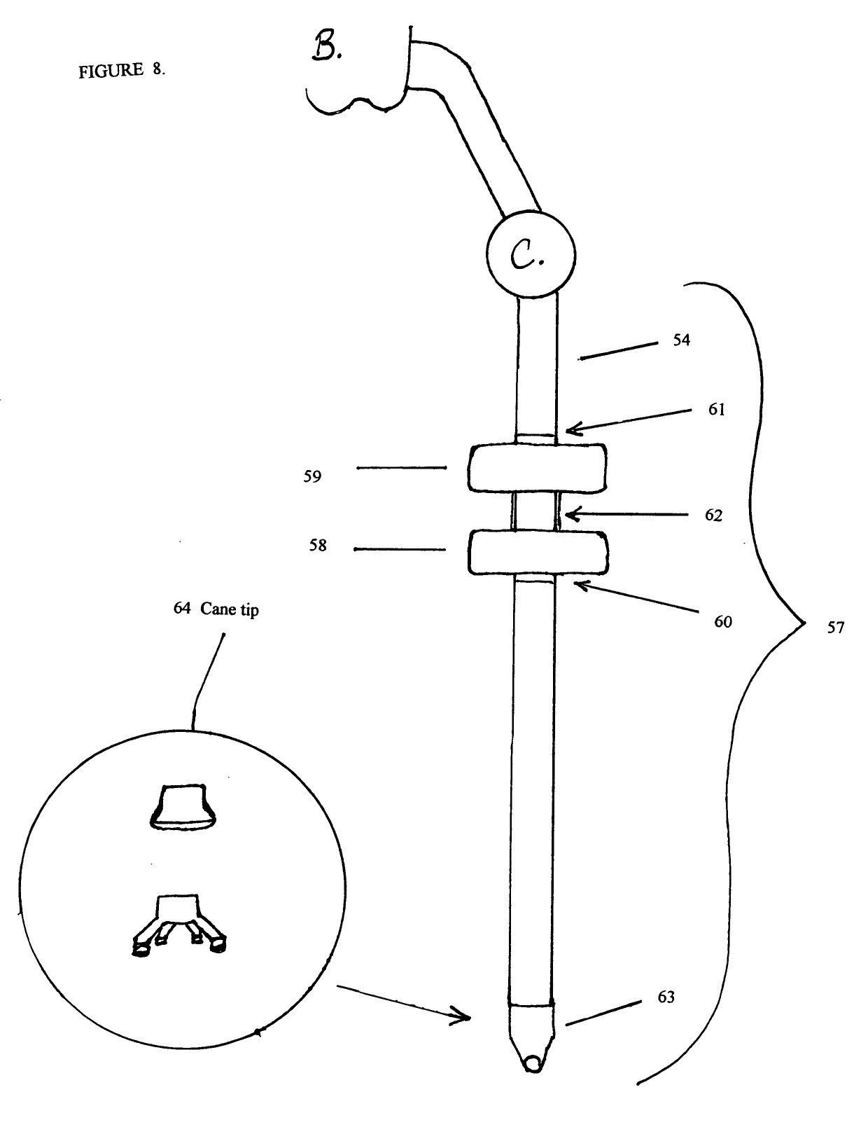

“Elongated shaft” or “shaft” means element 57 in FIG. 8.

“Enhances a user's grip” means that an element of the device, such as the third hook side, can be manufactured, modified, or can comprise additional elements, that make it more “user-friendly” for use as a handle of a walking aid, e.g., when the device is used as a combination massage device and walking aid.

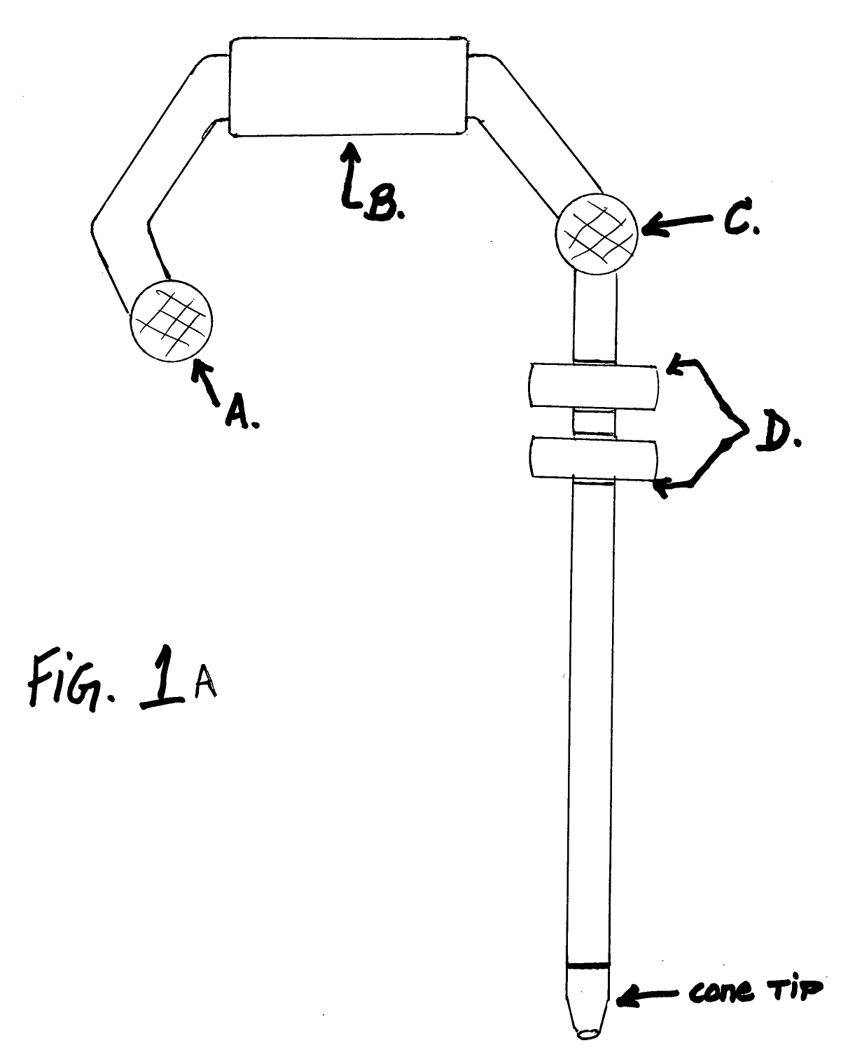

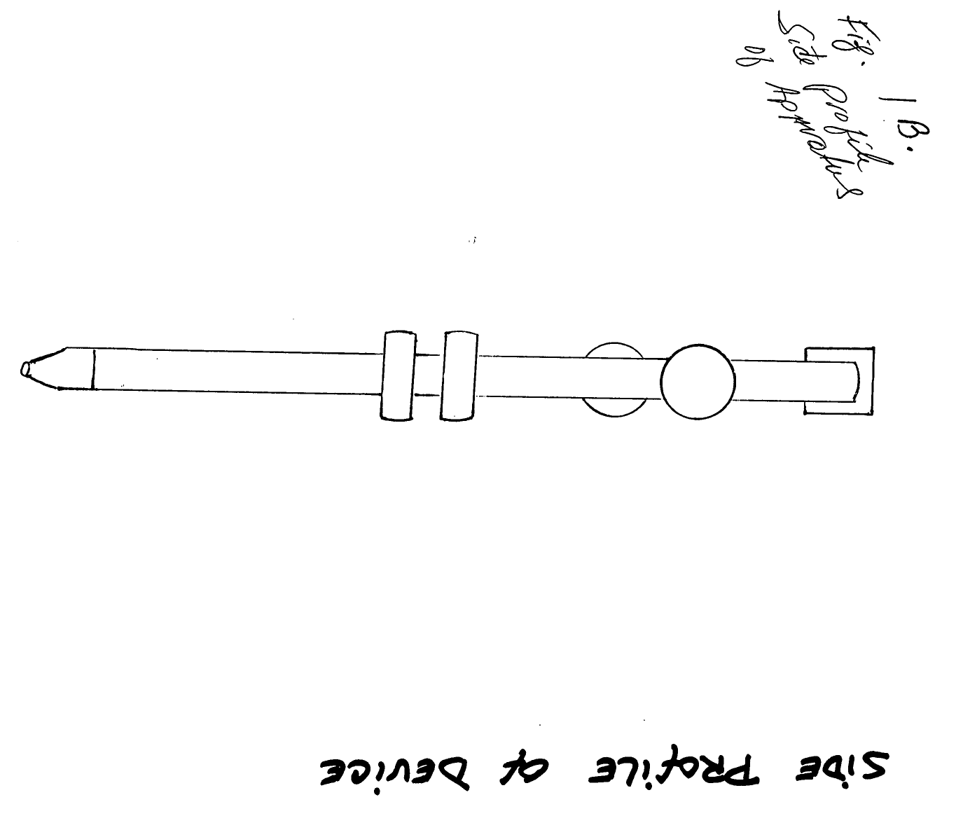

“Five-sided angled hook shape” means the five-sided hook that forms when a four-sided angled hook combines with the handle and the elongated shaft in the manner described herein and shown in FIG. 1A. A five-sided hook shape has a first side 50, a second side 51, a third side 52, a fourth side 53, and a fifth side 54 as shown in FIG. 7.

“Handle” means, in the context of this invention, and unless stated otherwise, element C in FIG. 1A. The handle of the present device generally serves as a fulcrum.

“Length of elongated shaft” means the distance from the first end of the elongated shaft (excluding the handle C) to the bottom of the shaft tip or the bottom of the cane tip.

“Massage head” means stationary or rotatable pressure applicator element, i.e., the elements of the present device that contact the user's skin or outer clothing and to which user force is transferred to thereby apply pressure to the targeted tissue site under the massage head. A massage head can be in any configuration and made of any material suitable for massage.

“Parallel rollers”, “parallel massage rollers”, and “parallel roller-type massage head” when used in context of the present invention are meant to be synonymous and mean the element D in FIG. 1A.

“Positioned” means the orientation of one element with respect to another, and includes orientations that are fixed or that can be modified, such as with a detachable or adjustable massage head.

“Self-massage” means a massaging or acupressure action that one can apply to one's back, spinal column area, hips, neck, waist, and other hard-to-reach areas without needing assistance from another individual or device.

“Telescoping” means that the elongated shaft comprises one or more features that enable the user to change the length of the shaft to fit the user's individual needs. Thus, a telescoping shaft can be extended from the second end of the shaft to lengthen the shaft or can be retracted into the inner portion of the second end of the shaft to shorten the length of the shaft. Extending or shortening the length of the shaft by adding or detaching separate length elements also is within the definition of telescoping.

“Textured” means that the surface has a texture other than a smooth. As disclosed herein, a textured massage head is better able to “grasp” muscle and connective tissue fiber and deliver the desired massage, than is a smooth massage head.

Words and phrases such as “joined”, “connected”, “attached” and similar words and phrases are meant to be synonymous and mean that at least two elements of the invented device are joined together or otherwise connected or affixed. The joining or connection may be in a continuous manner, such that there is not a break in the manufacture between one element and the other, it may be in a discontinuous manner, such that two or more elements are manufactured separately and then joined together to form a unit comprised of the two or more elements. The joining or connection may be permanent or temporary, such as the temporary joining of detachable massage heads, or embodiments of the present invention that contemplate some user assembly.

Words such as “massage” or “acupressure” are meant to be synonymous and mean the application of continuous or intermittent pressure to a chosen target site such as muscle, connective tissue, myofascia, nerves, and tissue surrounding the spinal column, for a therapeutic purpose, such as relaxation or relief of muscle tension.

Introduction to the Invented Device

The self-massage device of the present invention comprises an angled hook, two massage heads features, an elongated shaft of sufficient length to serve as an efficient lever and to permit positioning of the massage heads at desired locations, and a handle that can serve as a fulcrum. In one embodiment of the present invention, displayed in FIG. 1A, the massage head A is positioned at the first end of the angled hook, and a second massage head D, comprising a pair of parallel massage rollers, is positioned on the elongated shaft such that the rollers rotate in a plane perpendicular to the length, or longitudinal axis, of the shaft. The distance between the first massage head and the elongated shaft, and the length of the elongated shaft are chosen such that the distance and the length enable a user to position the massage heads at desired locations around the user's back, hip area, and torso. A handle C is positioned between the angled hook and the elongated shaft to serve as a fulcrum or pivot point for the shaft/lever. The user achieves a lever/fulcrum mechanical advantage when the device is used as described herein.

Each element of the present device, and its relation to the other elements, is described more particularly hereinbelow. While certain embodiments are featured for purposes of example more prominently than others, the present invention contemplates all embodiments and variables set forth herein and reasonable extensions thereof.

Unless stated otherwise, the device is made by usual and known means of manufacture and assembly, using the teachings herein as a guide to the unique structure and features of the device. Construction is with a durable (to withstand use), pliable (for manufacture), lightweight (for ease of use and portability) material, such as hollow aluminum tubing, although any sturdy, firm material, or combination of materials, may be used so long as the device maintains its structural integrity when pressure is applied. Examples of other materials that may be used include plastics, wood, metal, such as aluminum, steel, brass, copper, or a combination of such materials. Hollow aluminum tubing is a preferred material. In preferred embodiment, the angled hook and the shaft are manufactured using the same material and have the same circumference, and outer and inner diameters.

The general shape of the device is an angled hook on a shaft, wherein a cross-section of a preferred embodiment reveals the shaft and angled hook to have a substantially round shape; however, other cross-sectional shapes are also embodied in the invention, such as a square, hexagon, and the like.

Although the elements of the device are identified and discussed as individual parts, it is understood that two or more elements of the device may be manufactured as a single unit, may be contiguous with each other, or they may be made as separate parts joined together in the course of constructing or assembling the device. A choice between various methods of manufacture and/or assembly is made by the manufacturer after considering costs, timing, ease, and other factors not dependent upon the design of the claimed invention. As also described herein, some elements of the invented device may be joined by the user to assemble a complete device, and/or may be interchangeable, such as various detachable massage heads.

In certain embodiments, elements of the present invention are permanently affixed to the device, whereas other embodiments recognize that select elements of the device may be detachable or adjustable by the user. Methods of modifying an element to be detachable or adjustable, or to permit the attachment or adjustment of an element, are disclosed in the art and well known to those having the relevant skill.

The invented device massages and relieves tension and/or spasms when used as described herein and applied to the user's back, neck, legs, and hip area. Use of the device does not require the assistance of another person or device, and delivers a satisfying and effective massage to the target muscle or body area with minimal user effort. Using the specified methods, tense, spasmodic or sore muscles or muscle groups related to the target area remain in a relaxed or unflexed state while the user applies massage and pressure to the target area. The applied pressure relaxes the targeted muscles and/or tendons and stretches the area, increasing blood flow and relieving pain and spasm while increasing the user's flexibility, strength and athletic performance. Importantly, the device creates a lever mechanical advantage in use that significantly multiplies the user's effort and transfers the multiplied effort to the targeted massage head.

While not wishing to be bound by any particular scientific theory, the efficiency and special benefits of the invented device appear to be related to it functioning as an efficient lever/fulcrum mechanism. In simplest terms, a lever is a rigid bar that is free to turn about a fixed point of support, a fulcrum. When force is applied to a first end of the lever, such as by raising, pushing or pulling the end of the lever, the lever shaft pivots around the fixed fulcrum, and thereby transfers the applied force from the point of application to the other end of the lever. This combination of lever, fulcrum, and force creates a lever mechanical advantage that significantly multiplies the force applied, i.e., one unit of force applied to the first end of the lever results in more than one unit of force transferred and applied to the second end of the lever. Examples of levers that embody this principle include bottle openers, nutcrackers, and wheelbarrows. In each case, a small amount of force applied to the first end of a lever results in a multiplication and transfer of that force to the other end of the lever to do “work”, i.e., to apply force to an object (e.g., bottle cap, nut shell) to achieve a desired result.

In the present invention, the shaft serves as a lever and the handle C serves as a fulcrum. As discussed herein, in some embodiments the first massage head A can also serve as a fulcrum and in other embodiments the angled junction of the first hook side 50 and the second hook side 51 also can serve as a fulcrum (with references to FIGS. 1A and 7). The fulcrums can act in concert, individually, or in groups, depending on how the user positions and uses the device.

The “work” to be done through the lever/fulcrum mechanics is to transfer and amplify force from the user to a massage head and ultimately to the target muscle to effect acupressure or massage of the selected muscles, muscle groups, body areas, including the spine, neck, back, side, hips, legs, and shoulders. In one embodiment, the user places the device over one shoulder and positions the first massage head on a target muscle, e.g., a shoulder muscle. He then grasps the shaft at a point near its end and, with the other hand, grasps the fulcrum/pivot point, which is the handle C positioned in front of the shoulder to be massaged. Using the hand on the shaft end, the user moves the shaft away from his body maintaining a steady “fulcrum” hand. The combination of the user force applied to the lower part of the shaft/lever and the maintained fulcrum point, results in magnification of the applied force and transfer of this force to the targeted massage head.

The amount of force ultimately applied to a muscle through use of this lever/fulcrum mechanic can be calculated by the formula:
Work (w)=initial force (F) exerted×distance (d) over which the force is applied.

According to the equation, a constant force (F) can result in an ever-increasing level of work (w) solely by increasing the distance (d) over which the force is applied. In the present invention, the initial distance over which the force is applied is the distance between the user's two hands, i.e., the distance between the end of the lever and the fulcrum. Thus, if the fulcrum and end of the lever to which user force is applied are close together, a user must apply significantly more force to achieve the same level of work as would be achieved if the distance between the fulcrum and the lever were made longer.

According to one embodiment of the present invention, a device comprising an elongated shaft permits a high degree of force (or “work”) to be directed to a desired muscle or body area by applying only a relatively small amount of user force. Thus, the user can achieve a therapeutic or relaxing benefit with minimal movement of his arms to apply force, and/or with minimal muscle exertion or engagement of muscles associated with the targeted muscle group.

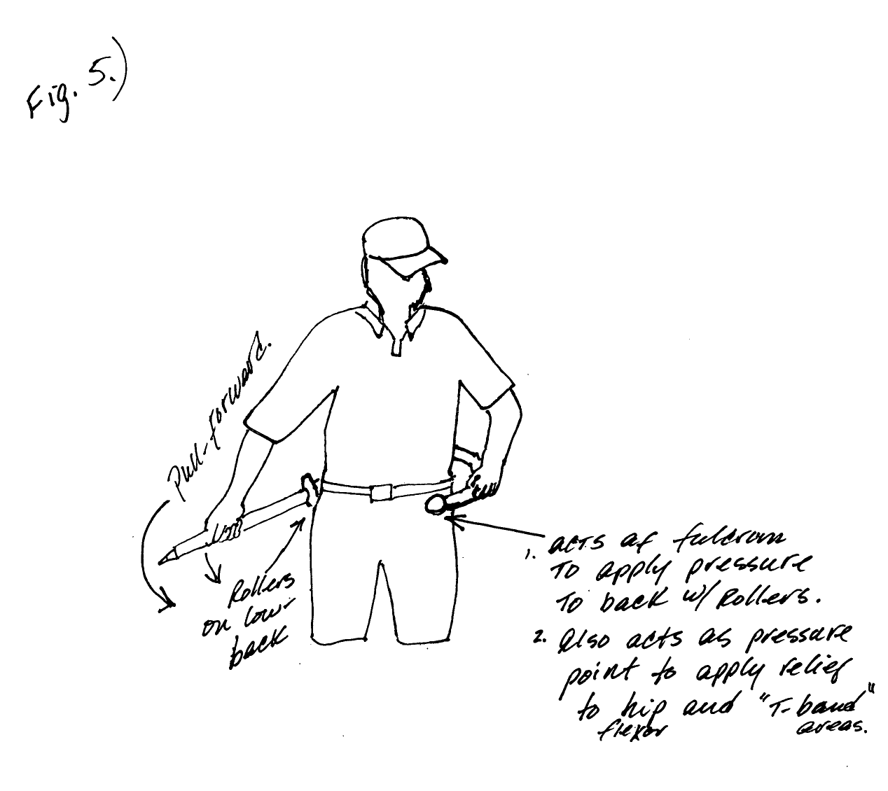

A lever working against several fulcrums simultaneously would be expected to magnify the lever/fulcrum effect. Without being bound to any particular theory or explanation, it appears that more than one element of the device can serve as a fulcrum at the same time. Thus, the angled junction formed by the first hook side 50 and the second hook side 51 (see FIG. 7) serves as a second fulcrum in some instances to further increase the energy transferred to the first massage head A. The first massage head A can itself also serve as a fulcrum in some uses, such as the use shown in FIG. 5.

Using the Invented Device

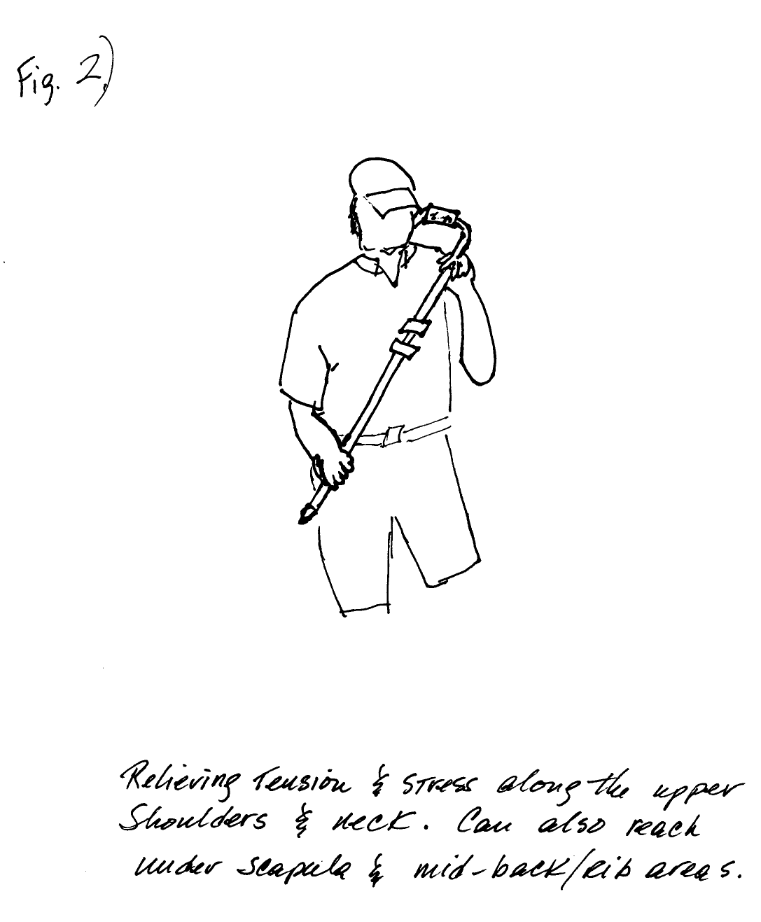

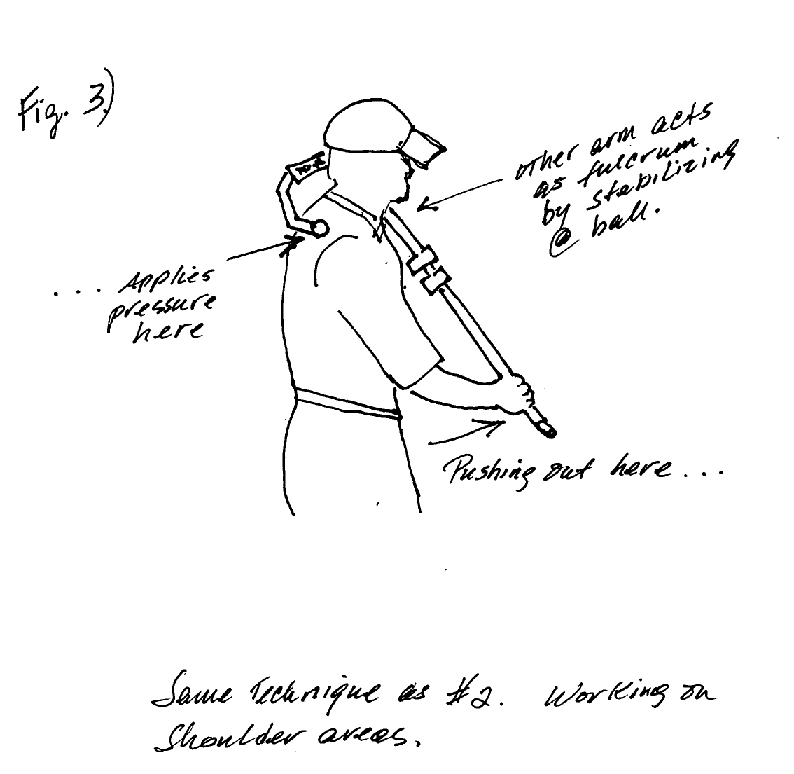

The device can be used in many ways. In one embodiment, shown in FIGS. 2 and 3, with reference to FIG. 1A, the device is placed over the user's left or right shoulder and used to relieve muscle tension in the upper back, shoulders and neck and scapula areas. In FIGS. 2 and 3, the device is placed over the user's left shoulder, with the massage head A placed on the user's left shoulder target area. With his right hand, the user holds the elongated shaft of the device near its end and with his left hand, holds the handle C of the device to stabilize the fulcrum or pivot point in front of his shoulder. He then applies pressure to the shaft with his right hand by pushing the shaft out and away from his body. The lever/fulcrum mechanics magnifies this pressure and transfers it first to the massage head A and then to the left shoulder area. In this embodiment, the lever mechanical advantage is thought to be attained by the user holding the handle C as a pivot point, while pushing the lower end of the shaft out and away from his body.

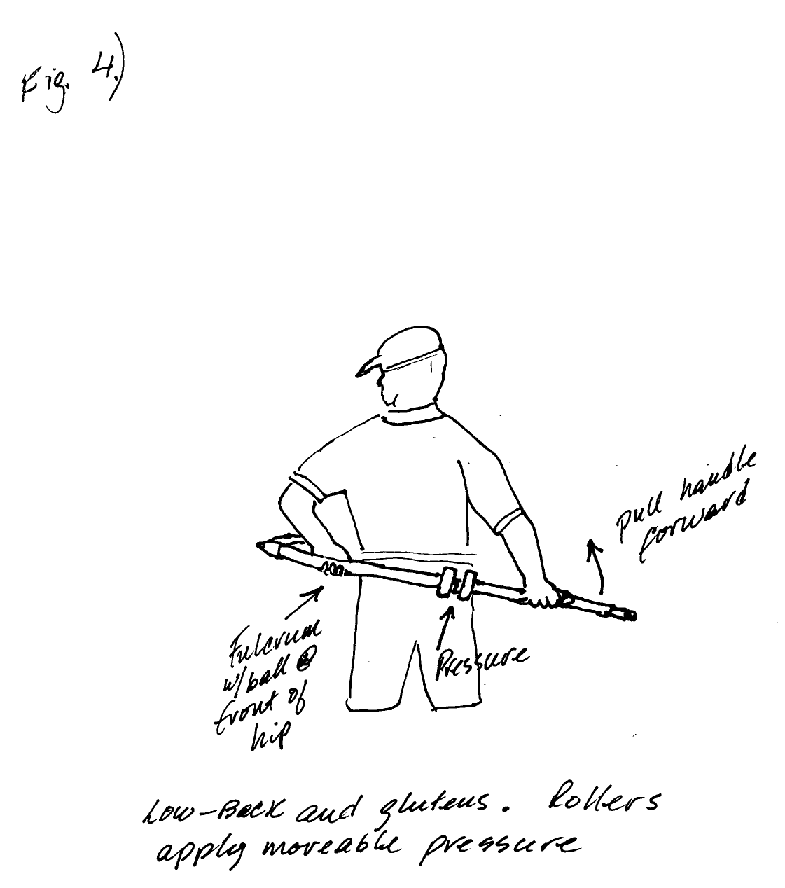

Another embodiment is shown in FIG. 4, with reference to FIG. 1A, whereby the device is turned horizontal and placed around either hip area of the user and used to relieve muscle tension in, for example, the illiotibial band, hips, lower back and gluteus area. In FIG. 4, the device is placed behind the user's body with the elongated shaft on the right side of the body and the inner edge of the angled hook portion wrapped around the left side of the body, curving around to the front of the user. The massage head A is placed at the front of the left hip to serve as a fulcrum as well as a pressure point for the front hip area, including the hip flexor and the illiotibial band. The parallel rollers D rest on the user's lower back, sciatic nerve area and gluteus muscle, creating pressure points at these sites. The user places his right hand at the lower end of the elongated shaft and his left hand on the handle C and pulls the shaft forward toward the front of his body. The user-applied force is amplified and transferred to the parallel rollers D and, thereafter, to the gluteus muscle. By moving the shaft up and down as well as forward, the user causes pressure to be transferred and applied to the parallel rollers D as they roll up and down the spinal area. The lever advantage is thought to be achieved in this embodiment by the acts of hooking the massage head A on the hip to act as a fulcrum and pulling the shaft/lever forward.

In yet another embodiment, displayed in FIG. 5 (with reference to FIG. 1A), the device is used to relieve muscle tension in and/or stretch the mid-back and entire spinal column using the parallel rollers D. The user places the device horizontally across his back with the two rollers straddling the spine. With the inside of the elbow joints around the bar, the user pulls his arms forward, creating pressure, and then rolls the rollers along the spine, increasing the pressure as needed by the amount of forward pull applied by the arms and arching and bowing of his back.

A further embodiment uses the device to relieve muscle tension in the front, rear, and sides of the legs. By hooking the inner edge of the angled hook portion around and behind the opposite leg of the targeted area, the user can spread his or her legs slightly and realize a similar leverage advantage to the above methods. Using the elongated shaft as a lever and the handle C as the fulcrum, the user rolls the parallel rollers along the targeted area. Additional pressure can be applied if desired by either pulling the shaft forward toward the body, or spreading his legs farther apart.

The present device is of particular benefit to athletes for relieving muscle tension, stiffness and spasm as well as decreasing edema caused by injury. It is able to reduce the “phantom” tension caused by stress that is present during competition. This is the one area athletes work so hard mentally to overcome, yet the stress-tension is physical as well as mental. The ability of the device to reach specific muscle groups and decrease spasm and lengthen connective tissue can help athletes prevent injury and enhance their performance. Nearly every sport or athletic endeavor creates ipsilateral strength and weakness. The invented device can correct this imbalance before, after and during athletic competition.

Amateur or professional athletes in sports, such as baseball, softball, football, soccer, tennis, biking, swimming, lacrosse, track and field, climbing, rowing, and the like suffer from muscle tension, stiffness and spasm and would benefit from use of the present device according to the disclosed methods. The invented device is especially suited for relieving muscle tension and spasm along the spinal column. Further, increasing blood flow to the muscles supporting the “core” of the body has a dramatic effect on strength and performance.

In particular, the invented device is well suited for massaging the back, neck, hip, and gluteus muscles of golfers. These muscles experience a high degree of stress and strain, particularly in amateur and weekend golfers. Golf is especially a one sided game. Releasing trigger points in the connective tissue of muscles in the back, neck and hips can elongate the muscles bringing the body back into balance. The present device was designed to be portable, so it can be used to release the trigger points between shots (or swings). The device is lightweight, compact, self-contained and self-sufficient, and does not require an electrical outlet or another individual for use. Moreover, the device easily fits in a golf bag, e.g., in the umbrella holder slot.

In further embodiments, the present device finds a variety of uses for physical therapy. The force amplification and transfer mechanics enables users who have limited strength and/or limited range of motion to use the device for a therapeutic or relaxing self-massage. Equally important, the angled hook and shaft permit a user to reach and massage hard to reach areas on his body with minimal effort. Moreover, use of the present device can help relieve pain for patients recovering from injury. Relaxed muscles, ligaments and tendons allow free blood flow, which is a key factor in the healing process.

In one embodiment, the massage head A is detachable from the first end of the angled hook and can be replaced with alternate massage heads designed to achieve different massage objectives. This, too, is of particular value to physical therapy patients. In another embodiment, the parallel massage rollers D or the pair of massage heads D are likewise detachable from the elongated shaft and can be replaced with alternate pairs of massage heads or parallel rollers. Thus, other embodiments of the invention comprise the device and a kit of detachable first massage heads and/or detachable parallel massage rollers D or pair of massage heads D.

An additional embodiment of the invention contemplates the elongated shaft being configured to have an end point and to be of a length that permits the device to be used as a self-massage device and as a walking aid, akin to a cane. As described more completely below, the angled hook is particularly well suited to withstand the force applied to the handle of a cane by a user.

Angled Hook

As shown in FIGS. 1A and 7, the present device comprises an angled hook having a first end and a second end. The angled hook is a laterally extending hook shaped element, having an inner edge and an outer edge, comprising two or more hook sides each of which joins with its adjacent side at angle. At minimum, an angled hook comprises a first hook side and a second hook side. In a preferred embodiment, the angled hook element has four sides and, when combined with the handle and the elongated shaft, forms a five-sided angled hook shape.

In a preferred embodiment of a five-sided angled hook shape, the angled hook is formed by joining the second end of the first hook side 50 with the first end of the second hook side 51; joining the second end of the second hook side 51 with the first end of the third hook side 52; joining the second end of the third hook side 52 with the first end of the fourth hook side 53; joining the second end of the fourth hook side 53 with the first end of handle C; and joining the second end of handle C with the first end of the shaft top 54. When all elements of the angled hook are combined, the angled hook has five sides, i.e., 50, 51, 52, 53, and 54. Massage head A joins the angled hook at the first end of the angled hook.

Although the terms “combining” and “joined” are used herein, it is understood that the combination or joining of the aforementioned elements can be accomplished in a variety of manners and through use of a variety of parts. For example, each element may be manufactured separately and then combined to form the angled hook. Alternatively, using a five-sided angled hook shape as an example, the first through fourth hook sides (50-53) may be manufactured as a single unit, which can be attached at the first end of the unit to the second end of the first massage head A and, at the second end of the unit to the first end of the handle C. Likewise, the second, third, and fourth hook sides 51, 52, and 53 can be manufactured as a single unit and then joined, at its first end, to the second end of the first hook side 50, and at the second end to the first end of the handle C, which itself is joined to the first end of the shaft top 54, i.e., the handle is joined to the shaft 57. These alternatives are meant to be illustrative and not exhaustive. The angled hook can be manufactured and assembled in any manner that maintains the features and their advantages, as described herein below, and results in an angled hook or, preferably, a five-sided angled hook.

The angled hook of the present invention was designed to satisfy at least four criteria:

First, to maximize the lever/fulcrum advantage, it is advantageous to have the fulcrum in close proximity to the point to which the user's force is to be transferred; that is, the shorter the distance between the fulcrum and the end of the lever to which force is to be transferred, the more lever advantage is realized. In the present device, the primary fulcrum is handle C and one of the points to which force is to be applied is the massage head A. As clearly shown in FIG. 1, the angled hook of the present invention places the first massage head A and the handle C in close proximity, while providing the other advantages set forth herein.

Equally important is the angle formed by the junction of the first and second hook sides 50 and 51. While not wishing to be bound by a particular theory, it is believed that this angled junction serves as a second fulcrum point to further amplify and transfer user applied force to the first massage head A; much like the use of a second or even third pulley mechanism to more easily lift a heavy weight. The distance between this second fulcrum point and the massage head A is even shorter than that between the handle C and the massage unit A and, thus, is thought to provide additional amplification of the transferred energy. In preferred embodiments, massage head A is at a position lower than handle C when the device is viewed in cross-view or when the device is standing uprights with the end of the elongated shaft on a solid surface.

Second, in embodiments when the device can be used as a combination cane or walking aid and as a self-massage device, one of the hook sides serves as a cane handle. In a preferred five-sided angled hook shape, the third hook side 52 serves as a cane handle. Accordingly, the design of the hook is such that it can support and withstand the force of a user's weight, particularly at the main stress point, e.g., third hook side 52. Without wishing to be bound by any particular theory, it appears the design of the present invention borrows from the physics of bridge design, with the five-sided angled hook forming an especially strong supported arch structure akin to a supported arch bridge. Forces acting on an arch extend outward and downward in a process called compression. When the compressive force is greater than the ability of an arch to withstand such force, the arch buckles. Arch bridges are made resistant to buckling through use of abutments, which are supports placed at both sides of an arch. When force is applied to the center, or arc, of an arch bridge with abutments, the force moves along the arc to the abutments, which push back on the arch. This prevents the ends of the arch from spreading apart and thereby allows the arch to maintain the compressive load.

In the angled hook design of the present invention, one of the hook sides, e.g., the third hook side 52 in a five-sided angled hook shape, is the apex of the arch and is the point that receives most compressive force when relied upon to support a user's weight. The applied force is transferred to the junctions where the first and second ends of the third hook side 52 join with the second end of the second hook side 51 and the first end of the fourth hook side 53, respectively. The angular junctions are believed to serve as abutments that push back on the third hook side 52 to both prevent it from buckling and allow it to support the user's weight. In turn, the first hook side 50 and the combination of handle C and the shaft top 54 serve are believed to serve as additional abutments for the second and fourth hook sides 51 and 53. The net result is that the angled hook element of the present invention is able to withstand more force without buckling than a convention curved, but not angled hook of similar size (length, radius, inner and outer diameter). Moreover, because the present angled hook can withstand more applied pressure than a conventional hook shape, it can be manufactured with hollow tubing having thinner walls and a smaller inner and outer diameter than needed for a conventional hook shape, which saves manufacturing costs and maintains the lightweight, portable nature of the device.

Third, the hook needed to be of a shape and size that fits over the shoulders and around the torso or waist of users having a variety of sizes. By manufacturing the present hook in a segmented or angled fashion, instead of in a conventional J-shaped fashion, the present hook structure has a long inner edge length that accommodates the shoulder, waist or torso of differently sized users, while maintaining a relatively compact shape.

And, fourth, the hook needs to be of a shape and size that allows the massage head A and the parallel rollers D to be correctly positioned on target tissues when the device is used in multiple embodiments by variable sized users. As shown in FIGS. 4 and 5, the present angled hook is of a size and shape for encircling a user's torso and thereby correctly positioning the parallel rollers D along the spinal column. With respect to the massage head A, it is joined to the angled hook at an angle, which is ultimately defined by the angled junction of the first and second hook sides 50 and 51. Not only does this angle, which may be adjustable, recognize the variability of user size, but it is this angled position of the massage head A that significantly contributes to the efficient and new function of the present device, i.e., the massage head A digs in and up into the muscle instead of just pushing the skin over the muscle.

In one embodiment, a preferred length of the inner edge 55, as measured from the first end of the angled hook to the second end of the angled hook (i.e., the length of the first, second, third, and fourth hook sides), is selected from inner edge lengths 17 to 25 inches. A preferred embodiment comprises a five-sided angled hook shape having an inner edge length, as measured from the first end of the first hook side 50 to the second end of the fifth hook side 54 (i.e., the length of the first through fifth hook sides), of 18 and ½ inches.

In a further embodiment, the distance between the massage head and the elongated shaft, as measured by an imaginary straight line drawn from a point on the massage head that faces the elongated shaft 54, to the point on the shaft 54 that is perpendicular to the shaft, is at least 6 inches. In a preferred device, this distance is 9 to 9 and ½ inches.

In another embodiment, the preferred lengths of the hook sides 50, 51, 52, and 53 in a five-sided angled hook shape, and the preferred length of the elongated shaft, as measured from the first end of the elongated shaft (excluding the handle C) to the bottom of the shaft tip or the bottom of the cane tip, are as set forth in Table 1:

TABLE 1

| | | Especially |
|---|---|---|
| | Range of | Preferred |
| Hook sides and | lengths (in | lengths (in |
| shaft length | inches) | inches) |
| First hook side | 2 to 6 | 2.5 to 3.5 |
| 50 | | |
| Second hook | 4 to 8 | 5 to 6 |
| side 51 | | |
| Third hook side | 5 to 8 | 6.5-7.5 |
| 52 | | |
| Fourth hook | 3 to 8 | 6 to 7 |
| side 53 | | |
| Fifth hook side | 1 to 2.5 | 1 to 1.5 |
| 54 | | |
| Length of | 12 to 35 | 26 to 29 |
| elongated | | |
| shaft* | | |

*It is understood that the length of the elongated shaft includes the length of the fifth hook side 54, as that fifth hook side forms the top portion of the elongated shaft.

Table 2 displays embodiments comprising an angled hook element having preferred sizes of the angles formed when a hook side is joined with the adjoining hook side to form an angled junction:

TABLE 2

| | | Especially |
|---|---|---|
| | Range of | Preferred |
| Angle formed when the | angle size (in | angle size (in |
| stated sides are joined | degrees) | degrees) |
| First hook side 50 joined | 25-90 | 35-45 |
| with second hook side 51 | | |
| Second hook side 51 joined | 28 to 50 | 44 to 48 |
| with third hook side 52 | | |
| Third hook side 52 joined | 40 to 55 | 49 to 53 |
| with fourth hook side 53 | | |
| Fourth hook side 53 joined | 20 to 30 | 23 to 25 |
| with Handle C | | |

In certain embodiments, one of the hook sides, such as third hook side 52 in a five-sided angled hook shape, can be modified to include a brand marking feature, such as brand labeling, customer corporate logos, or personalization. For instance, when the angled hook is configured out of cylindrical tubing, such as hollow aluminum tubing, all or part of a hook side, e.g., the third hook side 52, can be flattened and labeled for branding. Such labeling may be embedded in the hook side itself, e.g., embossed or stamped, or may be applied via a separate element, such as a sticker or decal. Alternatively, a separate sleeve can be inserted over all or part of hook side to accept and display the brand marking feature. Such a sleeve could be permanently affixed, removable, rotatable or stationary, made of cloth or spongy material, or made of a sturdy material such as wood, aluminum, plastic, polymer and the like. One preferred embodiment comprises a rectangular covering made of aluminum that is affixed, permanently or in a removable manner, over a hook side and used for labeling. A preferred embodiment places such a rectangular covering over or within third hook side 52 in a five-sided angled hook shape. Other portions of the device can similarly be modified to comprise or include a brand marking feature. The specific examples provided herein are illustrative only and not meant to be exhaustive.

In other embodiment, when the present device is configured for use as a self-massage device and a walking aid (cane), one hook side, such as the third hook side 52 in a five-sided angled hook shape, can comprise a feature to improve its use as a handle. For instance, the hook side could be configured to adapt more easily to a user's hand, to have improved ergonomics, to be padded, spongy, made of leather, or otherwise more comfortable for the user to grip.

The first end of the angled hook, e.g., the first hook side 50 in a five-sided angled hook shape, comprises a feature that joins to the massage head A. The feature can permanently affix the massage head A to the angled hook, or it can permit massage head A to be detachable from the angled hook and replaced with one or more alternative first massage heads. In a preferred embodiment, the first end of the angled hook comprises a feature that permits attachment of detachable massage heads. In a further preferred embodiment, this feature permits a user to vary the distance between the first end of the angled hook and the massage head A. This variability increases the versatility of the device in that it serves as a sizing feature. A user can shorten this distance to increase the area within the angled hook to accommodate a larger body shape, or can lengthen this distance to accommodate a smaller body shape. In one embodiment, the largest variable distance between the first end of the angled hook and massage head A is about 5-6 inches.

Other embodiments of the device contemplate that the first end of the angled hook is configured such that a user can vary the inner edge angle formed when massage head A joins to the angled hook. That is, the inner edge angle formed where the two elements join can be made larger by positioning the massage head A toward the outer edge 51 of the angled hook, or it can be made smaller by positioning the massage head A toward the inner edge 55 of the angled hook. This embodiment permits a user to vary the position of the massage head A relative to the angled hook, as well as to the elongated shaft. This embodiment can be a feature of either detachable or permanently affixed massage heads 50.

A further embodiment directed to varying the angle of the massage head A contemplates adjusting the angle formed where the first and second hook sides join. The angled hook can be manufactured to be adjustable at this point, provided that, once the desired angle is selected and the first and/or second hook sides are so adjusted, the position of the first and second hook sides is secured in a manner that permits the angle to withstand user force. The adjustment contemplated by this invention can be achieved by a ratcheting mechanism or similar device, and securing can be by a locking mechanism. A user may wish to adjust this angle in order to adjust the distance between the massage head and the elongated shaft and thereby adjust the lever/fulcrum mechanical advantage and/or adjust the angle to provide a sizing feature related to the area within the angled hook shape.

Massage Head A

The massage head A is positioned at the first end of the angled hook, e.g., the first end of first hook side 50 in a five-sided angled hook shape, and can be permanently affixed to the device or can be detachable. In preferred embodiments, the massage head A is detachable from the angled hook. In other embodiments, the detachable massage head A may be attached to the first end of the angled hook in a manner that increases or decreases the distance between the two elements and/or increases or decreases the size of the angle formed when the two elements are joined. Means of permanent or detachable affixation are well known to those of skill in the art and, for example, are described in U.S. Pat. Nos. 6,758,826 and 5,848,980, the contents of which are hereby incorporated herein by reference in their entirety. In preferred embodiments, massage head A is positioned such that it is at a position lower than handle C when the device is viewed in cross-view or when the device is standing uprights with the end of the elongated shaft on a solid surface. This positioning was found to enhance the lever/fulcrum mechanical advantage.

The massage head A can be configured in any manner designed to provide a massaging action, such as a round ball-like unit, a flattened unit of any shape, such as a rectangular, circular, triangular, or a knob-like structure. The surface of the massage head A can be smooth or textured, can have an outer surface comprised of fabric, such as felt, and can comprise extensions, such as nubs, to enhance the massage action. Further, the massage head A can be a vibratory unit, a heated unit, a lotion or oil dispensing unit, a pulsing unit, or the like. The overall feel of the massage head A can be hard or soft, such as hard rubber or a soft, spongy rubber. Whatever the exact configuration or material, the massage head A is made to withstand pressure applied to the device via the lever/fulcrum mechanism, but light enough to maintain its portability. A preferred material for the first massage head A is durable plastic. Examples of configurations of units suitable for the massage head A are disclosed in U.S. Pat. No. 6,758,826, the contents of which are hereby incorporated herein by reference in their entirety. The massage head A may be made of any durable, and lightweight material, such as plastic, wood, metal, rubber, or a polymer that provides a massaging action.

In one preferred embodiment, the massage head A has a dimpled or textured surface that “grabs” or adheres to the muscle fiber to be massaged. When massage heads contact the surface to be massaged, and they do not adhere or engage the muscle to be massaged, then the user may only be pushing the skin over the muscle and may not derive the massage benefit that was sought.

In another preferred embodiment, the massage head A has a ball shape.

The shape and configuration of the massage head A may also be adapted to a specific market. For instance, in one embodiment the massage head A is a golf ball-shaped unit, having dimples similar to those of a golf ball, and sized similar to a golf ball. Other embodiments comprise a massage head A configured as a tennis ball, a baseball, a basketball, or a soccer ball.

The use of various configurations of massage heads A for massage of specific muscles, muscle groups, or body areas, or to achieve a specific massage effect, is well known. For instance, it is known that a user having weak muscles, such as an elderly or injured user, would prefer a massage head A that is softer or spongier than a massage head to be used by an athlete to massage a sore muscle. A user of the present device will choose the type of massage head A based on the type of massage treatment he desires.

An embodiment of the present invention is a kit comprised of the present self-massage device and a selection of two or more detachable massage heads A, along with written directions for use.

Elongated Shaft

The present invention comprises an elongated shaft 57 (see FIG. 8), comprising a first end that joins to the second end of handle C, and a second end, optionally comprising a finishing tip 63 or a cane tip 64. Positioned on the elongated shaft 57 are parallel rollers D and optional spacers 60, 61, and 62. The elongated shaft 57 is multifunctional: it provides a supporting rod for the angled hook, it can serve as the shaft of a walking stick/cane and, importantly, is used as a lever to create a lever/fulcrum mechanic with the handle C.

As discussed above, and shown in FIGS. 2-5, the user applies minimal force to the elongated shaft 57 as a means to transfer and apply magnified force to the massage head A or the parallel rollers D. Because there is a direct relationship between the length of a lever and the “work” or applied force transferred from the lever to a massage head, the longer length of elongated shaft 57, as compared to the lengths of handles of more conventional self-massage devices, is an important feature of this invention. A self-massage device comprising a longer shaft, such as the present device, is especially useful for individuals having limited arm mobility or other limitations making it difficult for them to apply much initial force to the shaft 57.

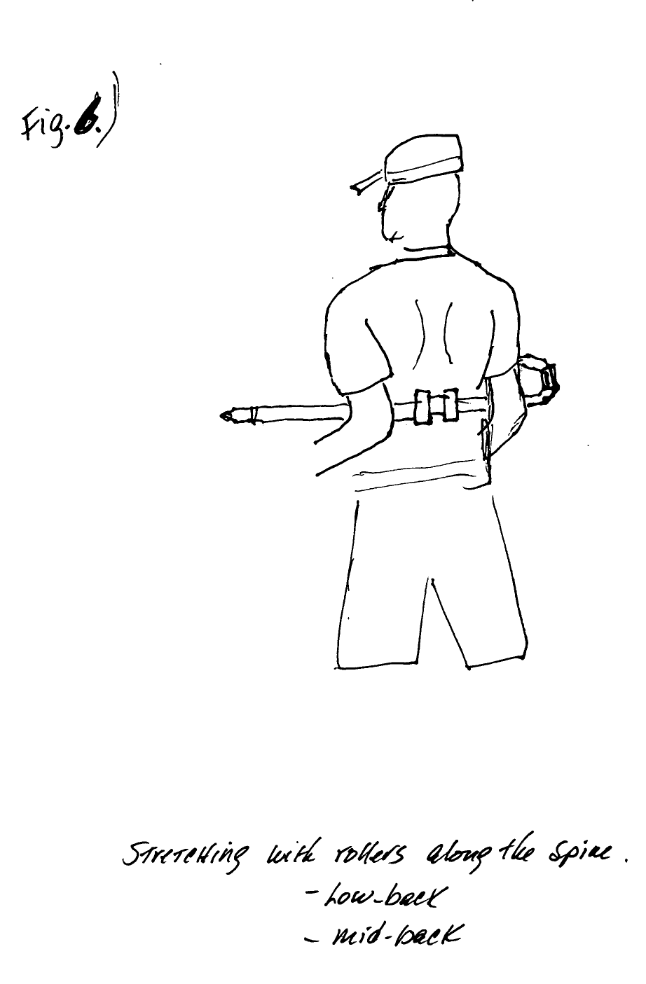

The longer elongated shaft length of the present device also permits the device to be used in manners not possible with self-massage devices having short handles or shafts. As shown in FIG. 6, a user can position the present device around the back of his body, place the parallel rollers D along his spine, and wrap his elbows around one end of the shaft 57 and handle C and proceed to massage his spine area with parallel rollers D. The longer elongated shaft also allows a user to position the device around his body, as shown in FIGS. 4 and 5, and hold the end of elongated shaft 57 behind him to act as a lever. Hence, the longer elongated shaft 57 permits the present device to be used in methods that would not be possible with massage devices having shorter shafts or conventional handles.

Moreover, in certain embodiments particularly well suited for users desiring massage as a form of physical therapy, elongated shaft 57 of the present device functions as the shaft of a walking stick or cane. This use would not be possible with devices having short handles or minimal shafts.

The elongated shaft of the present invention is of sufficient length to serve as an efficient lever and to permit positioning of the massage heads at desired locations, particularly in hard to reach locations on a user's back, hips, shoulders.

In certain embodiments, the elongated shaft can be a telescoping shaft such that the length of the elongated shaft can be varied by the user. The cane art has many examples of telescoping canes that can be manipulated by a user to be longer or shorter in length. See, for examples, U.S. Pat. No. 6,595,226, the contents of which are incorporated herein by reference in their entirety. Further, art related to umbrella handles, canopies, or any structure with legs that can be sized provides examples of how to make telescoping units. The present invention also contemplates adjusting cane length by manufacturing the elongated shaft in a manner that allows the shaft to accept additional shaft portions to increase shaft length either permanently or temporarily. Such art can be applied to the present invention to provide for telescoping devices and devices that permit user-defined length building.

This second end of elongated shaft 57 can be finished in a variety of functional or nonfunctional manners. In one embodiment, the second end of the elongated shaft 57 is joined to a tip 63 of any shape, such as a cone-shaped tip. In alternate embodiments, the second end of elongated shaft 57 can be finished without any tip to be flat or rounded. Those embodiments in which the device is configured for use as a self-massage device as well as a walking aid, preferably comprise a cane tip 64 to the second end of the shaft 57. The cane art has many teachings and examples of suitable cane tips 64 applicable for combination with the present device, such as a one-point tip or a four-pronged tip. The only requirement for a cane tip 64 is that it be of a material and shape that provides stability to the user and withstands normal wear and tear. Cane tip element 64 is not limited by the two examples provided in FIG. 8. Cane tips, and tips to the elongated shaft, may be permanently affixed or may be made to be detachable.

Positioned on elongated shaft 57 are parallel rollers D or a pair of massage heads, which are more particularly described hereinbelow, and one or more optional spacer elements 60, 61, and 62. (This discussion will use parallel rollers D as a non-limiting example of the massage head variables at this position.) Parallel rollers D are positioned on the elongated shaft 57 such that the rollers rotate in a plane perpendicular to the length of the shaft, and at a site that permits their use as a spinal massage device according to the methods of this invention. Thus, parallel rollers D are positioned on elongated shaft 57 such that the rollers 58 and 59 are parallel to each other and perpendicular to elongated shaft 57.

In terms of placement, the distance from the first end of elongated shaft 57 and the outer-facing edge of top roller 59 (i.e., the edge of roller 59 that faces away from the parallel roller pair) should be such that the parallel rollers straddle a user's spine when used as shown in FIG. 6 In a preferred embodiment, this distance is selected from distances between 5 and 7 inches. An especially preferred distance is 6 inches.

The parallel rollers D can be attached to elongated shaft 57 in a permanent or detachable manner using any conventional manner of attachment, provided the manner of attachment does not interfere with the movement of the parallel rollers or the use of non-moveable massage heads where configured as a pair. Conventional elements such as spacers 60, 61, and 62 may optionally be used to assist in the correct placement and retention of parallel rollers D or a pair of massage heads during manufacture or during user assembly or customization.

As described elsewhere, in several methods of the invention the user places one hand near the second end of the elongated shaft 57 and the other hand on the handle C or at some other relevant position on the device, such as the first massage head. Accordingly, this invention also contemplates the elongated shaft 57 of the device comprising a feature that provides one or more distinct gripping handles or grasping elements to the shaft near the second end of elongated shaft 57. Such handles would assist a user in correct hand placement, as well as guard against hand slippage. As with other elements of this device, optional shaft handles could be made to be detachable and/or moveable by the user, or the elongated shaft could be configured to embody the handles during construction, e.g., manufactured recessed areas for grasping.

In another embodiment, the elongated shaft 57 comprises a feature that permits elements to be attached and detached using snap-on clips. In this embodiment, elements such as the parallel rollers or one or more gripping handle are attached to such snap-on clips, which a user can optionally snap into the feature in the shaft and thereby attach the element to the shaft at a desired location. The feature on the shaft, coupled with the snap-on clip, provides a secure positioning system for required or optional elements of the present device.

When the present device is likely to be used by multiple users, as would be the case in hospitals, physical therapy units, gyms, locker rooms, and the like, then it is especially attractive to have the option of customizing features of the device for a particular user. The present invention permits the option of varying the length of elongated shaft 57 and/or positioning the parallel rollers, or optional features such as shaft handles, at a particular site desired by the current is user. These custom features, coupled with an array of detachable massage heads A, expand the utility of the present device.

Parallel Rollers or Pair of Massage Heads

The parallel rollers D comprise a pair of rollers 58 and 59. The rollers can be configured as a pair of wheels, balls, or any other rolling device, provided the configuration can straddle the spine and apply a massaging force to both sides of the spine simultaneously when the device is manipulated by the user. (The function of parallel rollers D as spinal massage heads defines certain parameters of the parallel rollers D, however does not restrict use of parallel rollers D to only the spinal area.) The shape of the parallel rollers D can be spherical like a ball, wheel-like, or cylindrical like a rolling pin. The parallel rollers 59 and 59 can be independently rotatable or can be configured to roll together in a dependent manner. Preferably, the parallel rollers are independently rotatable.

Preferably the two rollers 58 and 59 are the same size and shape as each other, however the invention contemplates embodiments where the size and/or shape of one roller is different from the size or shape of the other roller. Wheel-shaped rollers can be donut shaped rollers, designed to fit over and encircle elongated shaft 57. Alternatively, a wheel-shaped roller can be a canister-type wheel or ball-like roller that is mounted to a holder in a manner allowing free rotation of the wheel or roller and allowing attachment of the holder to the elongated shaft 57. Attachment of the parallel roller D to a holder can be by any manner known in the art that will maintain the function of the roller. Moreover, the pair of rollers 58 and 59 can be mounted on a single holder as a pair, or each can be separately mounted to its own holder. However, when the parallel rollers D are selected to be canister-type wheels, ball-shaped rollers, or any other roller that does not completely rotate around shaft 57, the rollers and/or their holders are affixed to the shaft 57 in an orientation that positions the parallel rollers D toward the massage head A, i.e., positioned on the inner edge of the elongated shaft.

When the rollers are donut-shaped wheels, a preferred outer diameter of each wheel is 2-3 inches, with an outer diameter of 2.75 inches being especially preferred. The preferred inner diameter of the wheel is slightly more than the outer diameter of the shaft, such that the roller can be inserted onto the shaft to encircle it, while maintaining free rotation. A preferred width, i.e., the distance from the inner edge of the wheel to the outer edge of the wheel, of each donut-shaped wheel is 1-2 inches, with a width of 1.75 to 1.875 inches being especially preferred.

Rollers 58 and 59 are configured in a side-by-side parallel orientation, such that parallel rollers D can straddle the sides of the user's spine and can be rolled along the side of the spine. Thus, the distance between the edges of the two rollers 58 and 59 that face each other, i.e., the inner-facing edges, is minimally the width of the spine and, for all practical purposes, no more than the width of the spine plus about less than two inches. In a preferred embodiment, the members of the pair of parallel massage rollers are spaced apart by a distance selected from the group consisting of distances between 1 inch and 4 inches, preferably a distance of 1¼ to 1½ inches.

The parallel rollers can be manufactured using any material that is sufficiently sturdy to withstand the pressure applied to the rollers during massage, sufficiently lightweight to maintain the portability of the present device, and sufficiently smooth so as to not create a level of friction that would impede the rolling movement of the rollers. Preferably, the rollers are manufactured using a material that does not leave a mark or discolor any clothes worn over the area to be massaged by the parallel rollers. A preferred material is plastic or nylon.

The surface of the rollers of the parallel rollers may be smooth or textured. A textured surface may include dimples or smooth nubs. Heavily textured surfaces, such as a prickly nub surface, are designed to stimulate the nerves during massage use and aid in pain relief. As with the massage head A, different shapes and types of rollers are more suitable for different types of massage objectives. In a preferred embodiment, the surface of the rollers is smooth to minimize catching on a user's clothing. In other embodiments, a flexible surface that “gives” with pressure is desired for rollers of the parallel rollers D.

The parallel rollers D are affixed to the shaft of the present device in either a permanent or detachable manner. Either way, the parallel rollers D may be assembled as a unit and attached to the shaft as a complete unit, or the elements of the parallel rollers may be separately attached to the shaft and thereby form the parallel rollers. The choice of either method of assembly is a design and manufacturing choice, as is the use of conventional elements such as spacers.

In one embodiment, the parallel rollers D comprise donut-shaped rollers that encircle the elongated shaft 57 at a selected location. In a preferred embodiment, the distance between the inner-facing edges of the rollers 58 and 59 can be fixed by placing one or more spacer elements 62 on the shaft 57 between the inner-facing edges such that the combined width of the one or more spacers, and any intervening shaft space, is equal to the desired distance between the inner-facing edges of the parallel rollers. Similarly, one or more spacer elements 60 and 61 may be affixed on the shaft along the outer edge of each roller 58 and 59 to maintain the desired position of the parallel rollers D. The use of one or more spacers is preferred when the parallel rollers D are donut-shaped.

In some embodiments, a pair of massage heads is positioned on the elongated shaft instead of the parallel massage rollers. The pair of massage heads is positioned on the elongated shaft such that the pair of massage heads is oriented perpendicular to the length of the shaft and the members of the pair are oriented parallel to each other. In such embodiments, the massage heads may be rotatable or fixed. They may be ball-shaped or have another configuration, may be hard or soft, and may be the same or different from each other, may be detachable or fixed, and may use spacers for positioning. The relative position of the members of the pair to each other are as stated for the parallel massage rollers.

Handle

FIG. 1A displays the handle C of the present device. Its position between the angled hook and the elongated shaft 57 defines its use as the fulcrum or pivot point when the present device is used to transfer applied pressure to one of the massage heads.

The handle C can be manufactured from any material that is sturdy, durable, and lightweight. It can have a variety of shapes and surface textures, so long as the shape and texture does not detract from the ability of a user to hold the handle C.

In a preferred embodiment, the handle C is shaped as a ball. In another preferred embodiment, the handle C and the first massage head A are similarly shaped so as to appear as a pair.

The shape and configuration of the handle C may be adapted to a specific market. For instance, in one embodiment the handle is shaped and sized as a golf ball with dimples. Other embodiments comprise a handle C configured as a tennis ball, a basketball, or a soccer ball, and having the same diameter and made as noted immediately above.

While various embodiments of the present invention are shown and described herein, various modifications may be made without departing from the scope of the present invention, and all such modifications and equivalents are intended to be covered.

1. A device useful for self-massage comprising:
a. an angled hook having a first end and a second end,
b. a massage head positioned at the first end of the angled hook,
c. an elongated shaft having a first end and a second end,
d. a handle positioned between the angled hook and the elongated shaft, and
e. a pair of parallel massage rollers positioned on the elongated shaft such that the rollers rotate in a plane perpendicular to the length of the shaft, wherein the elongated shaft is of sufficient length to serve as an efficient lever and to permit positioning of the massage head and massage rollers at desired body locations.

2. The device of claim 1, wherein the angled hook, the handle, and the elongated shaft together define a five-sided angled hook shape comprising four angles on its inner edge.

3. The device of claim 2, wherein the third hook side of the five-sided angled hook shape comprises a brand-marking feature.

4. The device of claim 2, wherein the third hook side of the five-sided angled hook shape comprises a feature that enhances a user's grip.

5. The device of claim 4, wherein the feature is selected from the group consisting of padding, ergonomic configurations, handle attachments and grasping indentations.

6. The device of claim 1, wherein the device comprises at least one feature that performs a function selected from the group consisting permitting the massage head to be detachable from the angled hook, permitting the massage head to be positioned at variable distances from the first end of the angled hook, and permitting the massage head to be positioned at variable angles from the first end of the angled hook such that the massage head is positioned at an angle toward or away from the elongated shaft.

7. The device of claim 1, wherein the massage head is textured.

8. The device of claim 1, wherein the elongated shaft is telescoping.

9. The device of claim 1, wherein the elongated shaft comprises a cane tip.

10. The device of claim 1, wherein the pair of parallel massage rollers are donut-shaped rollers that encircle the elongated shaft and that are freely rotatable around the shaft.

11. The device of claim 2, wherein the device comprises at least two additional features selected from the group consisting of a brand marking element, a detachable massage head, a telescoping elongated shaft, and a cane tip.

12. A device useful for self-massage and as a walking aid comprising:
a. an angled hook having a first end and a second end,
b. a massage head positioned at the first end of the angled hook,
c. an elongated shaft having a first end and a second end,
d. a handle positioned between the angled hook and the elongated shaft,
e. a pair of parallel massage rollers positioned on the elongated shaft such that the rollers rotate in a plane perpendicular to the length of the shaft, and
f. a cane tip, wherein the elongated shaft is of sufficient length to serve as an efficient lever and to permit positioning of the massage head and massage rollers at desired body locations.

13. The device of claim 12, wherein the angled hook, the handle, and the elongated shaft together define a five-sided angled hook shape comprising four angles on its inner edge.

14. The device of claim 12, wherein the device comprises at least one additional feature selected from the group consisting of a brand marking element, a detachable massage head, a telescoping elongated shaft, and a feature that enhances a user's grip at the third hook side.

15. A device useful for self-massage comprising:
a. an angled hook having a first end and a second end,
b. a massage head positioned at the first end of the angled hook, wherein the massage head is textured;
c. an elongated shaft having a first end and a second end,
d. a handle positioned between the angled hook and the elongated shaft, and
e. a pair of donut-shaped parallel massage rollers that encircle the elongated shaft and are freely rotatable around the shaft in a plane perpendicular to the shaft, wherein the angled hook, the handle, and the elongated shaft together define a five-sided angled hook shape comprising four angles on its inner edge, and wherein the elongated shaft is of sufficient length to serve as an efficient lever and to permit positioning of the massage head and massage rollers at desired body locations.

16. The device of claim 15, wherein the massage head is detachable from the angled hook and is positionable at variable distances from the first end of the angled hook.

17. The device of claim 15, wherein the device comprises at least one additional feature selected from the group consisting of a brand marking element, a telescoping elongated shaft, and a cane tip.

18. A device useful for self-massage comprising:
a. an angled hook having a first end and a second end,
b. a massage head positioned at the first end of the angled hook,
c. an elongated shaft having a first end and a second end,
d. a handle positioned between the angled hook and the elongated shaft, and
e. a pair of massage heads positioned on the elongated shaft such that the pair of massage heads is oriented perpendicular to the length of the shaft, wherein the elongated shaft is of sufficient length to serve as an efficient lever and to permit positioning of the massage head and massage rollers at desired body locations.

19. The device of claim 18, wherein the angled hook, the handle, and the elongated shaft together define a five-sided angled hook shape comprising four angles on its inner edge.

20. The device of claim 19, wherein the device comprises at least one feature that performs a function selected from the group consisting permitting the massage head to be detachable from the angled hook, permitting the massage head to be positioned at variable distances from the first end of the angled hook, and permitting the massage head to be positioned at variable angles from the first end of the angled hook such that the massage head is positioned at an angle toward or away from the elongated shaft.
